(19) United States
(12) Patent Application Publication
(10) Pub. No.: US 2026/0088553 A1
(43) Pub. Date: Mar. 26, 2026

(54) CONNECTOR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Tetsuya MIYAMURA, Mie (JP); Hajime MATSUI, Mie (JP)

(21) Appl. No.: 19/113,424

(22) PCT Filed: Sep. 14, 2023
(86) PCT No.: PCT/JP2023/033538

§ 371 Date: Mar. 20, 2025

(30) Foreign Application Priority Data
Oct. 3, 2022 (JP) 2022-159288

(51) Int. Cl. H01R 13/436

(52) U.S. Cl. CPC H01R 13/4361

(57) ABSTRACT

It is aimed to further reduce the size of a connector. A connector for holding a terminal includes a housing formed with a cavity capable of accommodating the terminal and a retainer attachable to the housing at a temporarily attached position and a completely attached position. The retainer includes a locking protrusion lockable to the terminal accommodated in the cavity. The locking protrusion is retracted from the cavity with the retainer located at the temporarily attached position, and projects into the cavity and locks the terminal in the cavity by rotating the retainer from the temporarily attached position to the completely attached position.

### TECHNICAL FIELD

The present disclosure relates to a connector.

### BACKGROUND

Patent Document 1 discloses a connector provided with a housing body portion formed with a cavity, into and from which a terminal fitting is insertable and withdrawal, and a retainer. The retainer is formed with a locking protrusion to be secondarily locked to the terminal fitting. The retainer is movable between a temporary locking position and a complete locking position with respect to the housing body portion. The insertion and withdrawal of the female terminal fitting are allowed at the temporary locking position, and the locking protrusion is secondarily locked to the female terminal fitting at the complete locking position.

### PRIOR ART DOCUMENT

### Patent Document

Patent Document 1: JP 2007-305473 A

### SUMMARY OF THE INVENTION

### Problems to be Solved

Here, it is required to further reduce the size of the connector.

Accordingly, the present disclosure aims to further reduce the size of a connector.

### Means to Solve the Problem

The present disclosure is directed to a connector for holding a terminal, the connector being provided with a housing formed with a cavity capable of accommodating the terminal, and a retainer attachable to the housing at a temporarily attached position and a completely attached position, the retainer including a locking protrusion lockable to the terminal accommodated in the cavity, and the locking protrusion being retracted from the cavity with the retainer located at the temporarily attached position, the locking protrusion projecting into the cavity and locking the terminal in the cavity by rotating the retainer from the temporarily attached position to the completely attached position.

### Effect of the Invention

According to the present disclosure, a connector is further reduced in size.

### BRIEF DESCRIPTION OF THE DRAWINGS

FIG. 1 is a perspective view showing a connector according to one embodiment.

FIG. 2 is an exploded perspective view showing the connector.

FIG. 3 is an exploded perspective view showing the connector.

FIG. 4 is a partial section along IV-IV of FIG. 1.

FIG. 5 is a side view showing the connector in a temporarily attached state.

FIG. 6 is a section showing the connector in the temporarily attached state.

FIG. 7 is a section along VII-VII of FIG. 5.

FIG. 8 is a section along VIII-VIII of FIG. 5.

FIG. 9 is a side view of the connector showing a state where a retainer is retracted.

FIG. 10 is a section showing the connector in the state where the retainer is retracted.

### DETAILED DESCRIPTION TO EXECUTE THE INVENTION

### Description of Embodiments of Present Disclosure

First, embodiments of the present disclosure are listed and described.

The connector of the present disclosure is as follows.

(1) The connector of the present disclosure is for holding a terminal and provided with a housing formed with a cavity capable of accommodating the terminal, and a retainer attachable to the housing at a temporarily attached position and a completely attached position, the retainer including a locking protrusion lockable to the terminal accommodated in the cavity, and the locking protrusion being retracted from the cavity with the retainer located at the temporarily attached position, the locking protrusion projecting into the cavity and locking the terminal in the cavity by rotating the retainer from the temporarily attached position to the completely attached position.

According to this connector, by rotating the retainer from the temporarily attached position toward the completely attached position, the locking protrusion can lock the terminal in the cavity and hold the cavity. Thus, a configuration for movably supporting the retainer can be reduced in size as compared to a configuration for positioning the terminal by the retainer moving in a direction orthogonal to a longitudinal direction of the terminal. In this way, the connector can be reduced in size.

(2) In the connector of (1), with a back side in an insertion direction of the terminal into the cavity set as a front side and an opposite side set as a rear side, the retainer may be supported movably along an inclination direction away from the cavity toward the rear side along an extension direction of the cavity at the temporarily attached position.

In this case, since the retainer is supported movably in the inclination direction at the temporarily attached position, the locking protrusion can move in the direction away from the cavity if the terminal contacts the locking protrusion during the insertion of the terminal into the cavity.

(3) In the connector of (1) or (2), with a back side in an insertion direction of the terminal into the cavity set as a front side and an opposite side set as a rear side, the housing may include an attachment opening, the retainer being attached into the attachment opening, the retainer may include a retainer body to be attached into the attachment opening, a pair of locking wall portions extending from both sides of the retainer body along both sides of the housing and a pair of retaining protrusions projecting from inner surfaces of the pair of locking wall portions, the housing may include a pair of temporary locking protrusions and a pair of complete locking protrusions projecting from outer surfaces on the both sides of the housing, the pair of temporary locking protrusions are located closer to the attachment opening than the pair of complete locking protrusions, an inclined temporary support groove extending in an inclination direction away from the cavity toward the rear side along an extension direction of the cavity and supporting the retaining protrusion in a posture along the inclination direction may be formed between the temporary locking protrusion and the complete locking protrusion, and a surface of the complete locking protrusion on a side opposite to the attachment opening may be a complete locking surface for keeping the retainer at the completely attached position by being locked to the retaining protrusion.

In this case, the pair of retaining protrusions are arranged in the inclined temporary support grooves, whereby the retainer is held at the temporarily attached position. In this state, the terminal is easily inserted into the cavity. If the retainer is pushed and rotated, the pair of retaining protrusions ride over the pair of complete locking protrusions and lock the complete locking surfaces. In this way, the retainer is held at the completely attached position and the terminal is retained.

(4) In the connector of (3), a back-side groove forming surface forming one groove side surface of the inclined temporary support groove, out of the complete locking protrusion, may be located near front of the complete locking protrusion, and the temporary locking protrusion may be located forward of a rear edge of the back-side groove forming surface in the extension direction of the cavity.

In this case, arrangement spaces for the temporary locking protrusions and the complete locking protrusions can be reduced in a vertical direction, which contributes to the size reduction of the connector.

(5) In the connector of (4), a part rearward of the back-side groove forming surface, out of the complete locking protrusion, may be formed into a retainer spreading surface having a projecting length from an outer side surface of the housing increasing with distance from the attachment opening, and the back-side groove forming surface and a front-side groove forming surface forming the other groove side surface of the inclined temporary support groove, out of the temporary locking protrusion, may be in a posture more perpendicular to the side surface of the housing than the retainer spreading surface.

In this case, with the retainer located at the temporarily attached position, the retaining protrusion is held in an inclined posture between the nearly perpendicular back-side groove forming surface and the front-side groove forming surface. Thus, the retainer is easily held in the inclined posture. If the retainer is rotated, the retaining protrusions contact the retainer spreading surfaces and the pair of locking wall portions are pushed apart from each other. In this way, the retaining protrusions can ride over the completely locking protrusions and are easily retained and locked to the complete locking protrusions.

(6) In the connector of any one of (2) to (5), a part configured to enter the cavity with the retainer located at the temporarily attached position, out of the locking protrusion, may be formed into a retracted guiding surface extending away from the cavity toward the rear side.

In this case, if the terminal contacts the retracted guiding surface of the locking protrusion when the terminal is inserted into the cavity, the locking protrusion is guided in a direction retracting from the inside of the cavity. In this way, the terminal is smoothly inserted into the cavity.

(7) In the connector of (6), the retracted guiding surface may be a surface facing the terminal from a direction to push the terminal into the cavity with the retainer located at the completely attached position, and a retaining surface for retaining the terminal with the retainer located at the completely attached position may be connected in front of the retracted guiding surface.

According to this connector, since the retainer is configured to rotate, the retaining surface is easily positioned to enter the cavity with the retainer located at the temporarily attached position. In such a case, if the terminal contacts the retracted guiding surface of the locking protrusion when being inserted into the cavity, the locking protrusion is easily guided in the direction retracting from the inside of the cavity and the retaining surface is also easily guided in the direction retracting from the cavity. In this way, the terminal is smoothly inserted into the cavity.

(8) In the connector of any one of (2) to (7), the housing may have a retainer retention receiving surface located behind the retainer located at the temporarily attached position to contact the retainer from behind.

In this way, the retainer is suppressed from coming out rearward from a state located at the temporarily attached position.

(9) In the connector of (8), the retainer may have an inclined retaining surface inclined with respect to the extension direction of the cavity in a state located at the completely attached position and facing rearward to face the retainer retention receiving surface in a state located at the temporarily attached position, and the inclined retaining surface may contact the retainer retention receiving surface to retain the retainer.

In this way, since the inclined retaining surface is in contact with the retainer retention receiving surface with the retainer moved in a coming-out direction, the inclined posture of the retainer in the retained state is stabilized. In this way, a return movement of the retainer is smoothly made later.

### Details of Embodiment of Present Disclosure

A specific example of a connector of the present disclosure is described below with reference to the drawings. Note that the present disclosure is not limited to these illustrations, but is represented by claims and intended to include all changes in the scope of claims and in the meaning and scope of equivalents.

### Embodiment

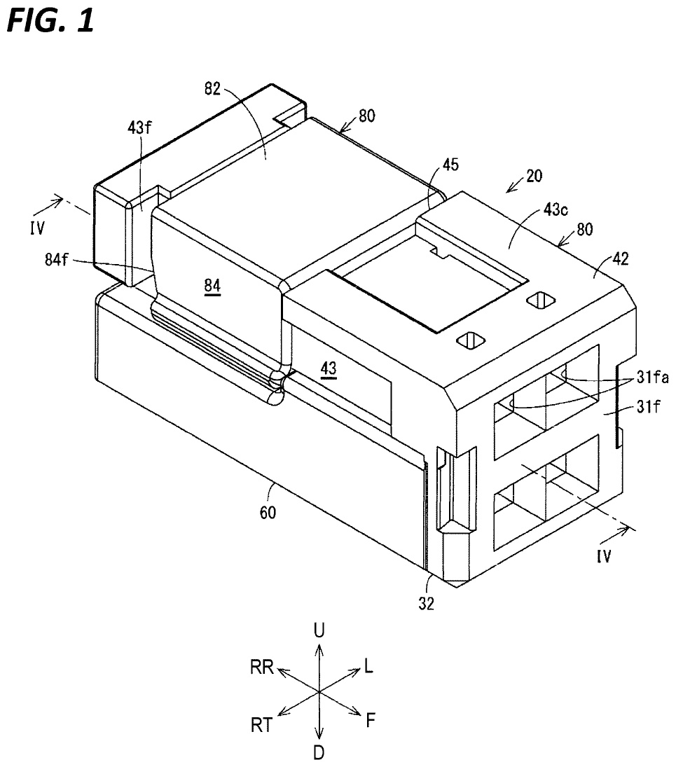

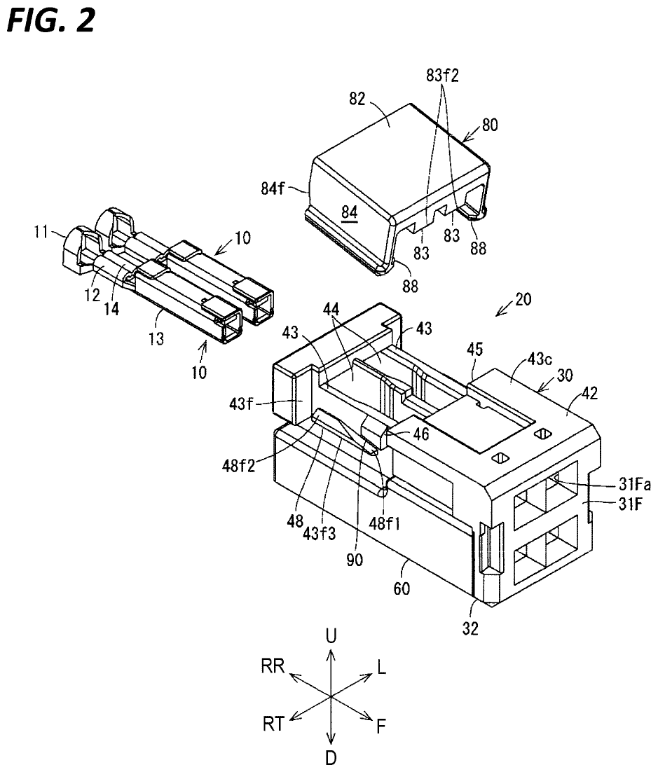

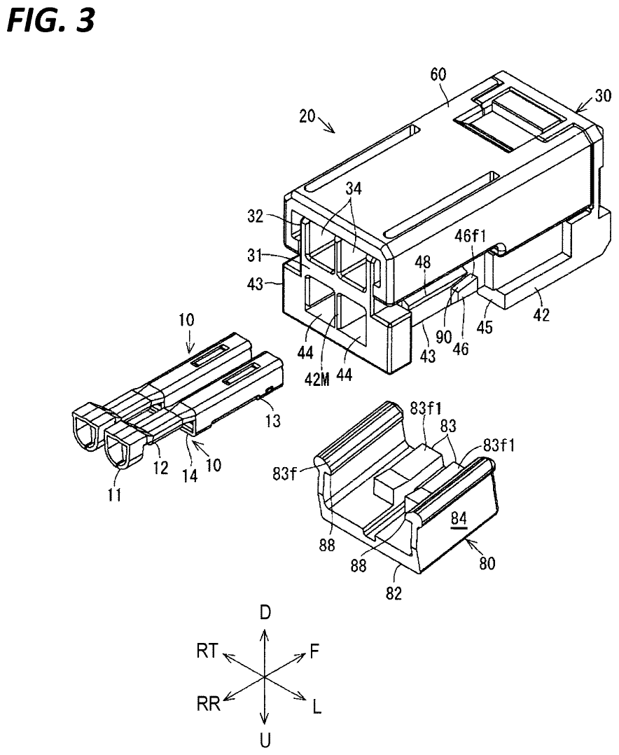

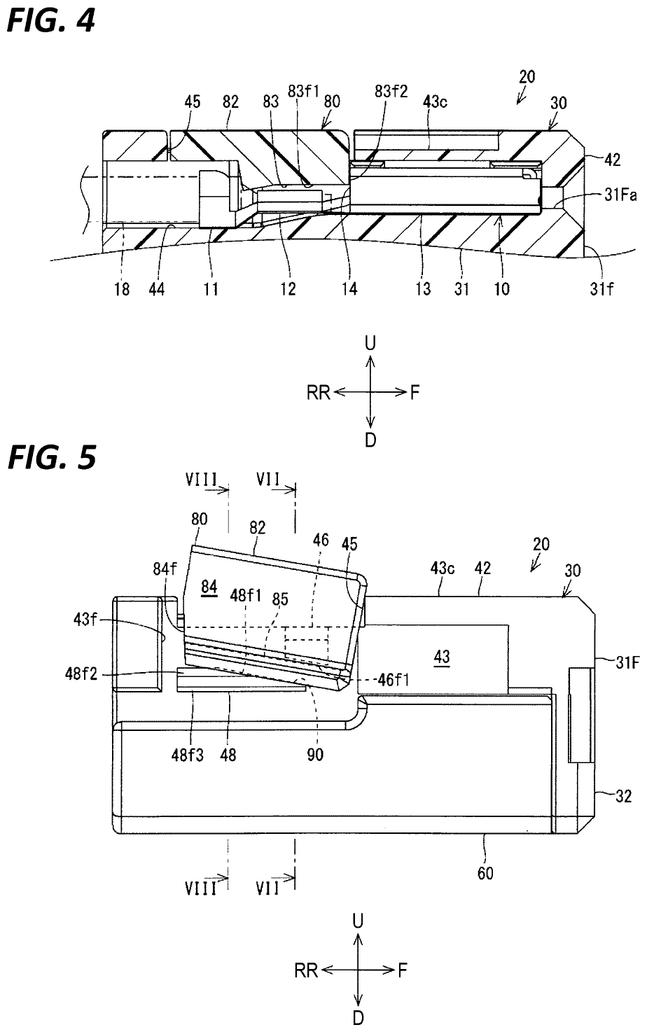

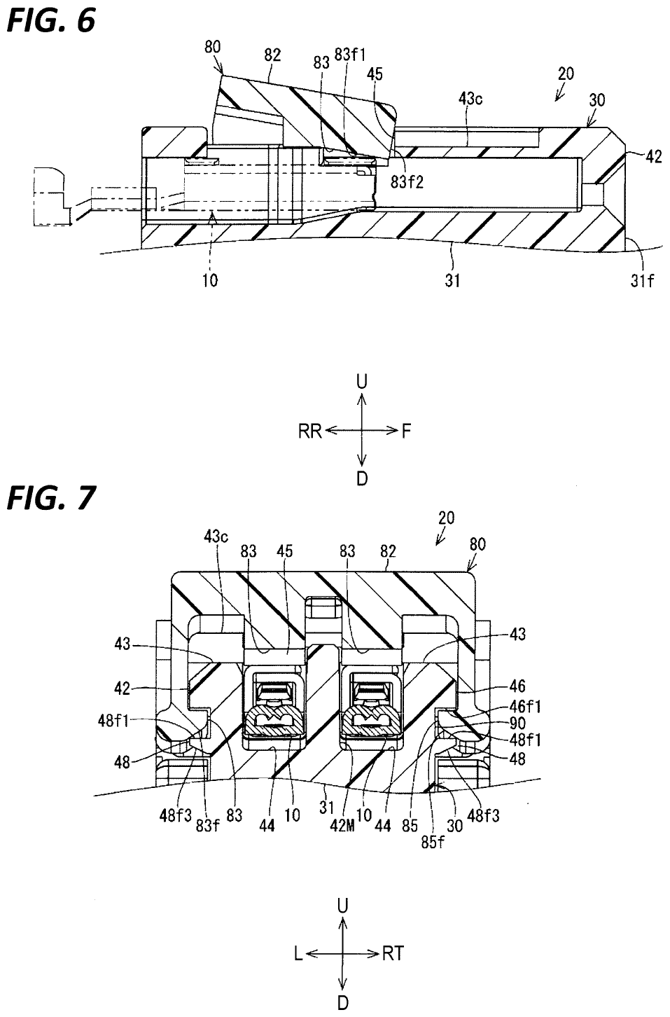

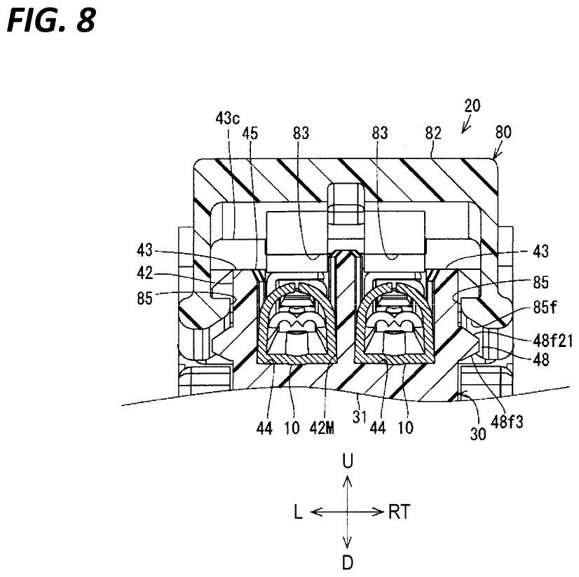

Hereinafter, a connector according to an embodiment is described. FIG. 1 is a perspective view showing a connector 20. FIGS. 2 and 3 are exploded perspective views showing the connector 20. FIG. 4 is a partial section along IV-IV of FIG. 1. A wire 18 is shown by a two-dot chain line in FIG. 4. FIG. 5 is a side view showing the connector 20 in a temporarily attached state. FIG. 6 is a section showing the connector 20 in the temporarily attached state. FIG. 6 is a section at the same position as IV-IV. FIG. 7 is a section along VII-VII of FIG. 5, and FIG. 8 is a section along VIII-VIII of FIG. 5. Note that the temporarily attached position state is a state where a retainer 80 is located at a temporarily attached position, and a completely attached state is a state where the retainer 80 is located at a completely attached position.

### Overall Structure of Connector

The overall structure of the connector 20 is described. The connector 20 holds terminals 10.

The terminal 10 is formed, such as by press-working a metal plate. The terminal 10 is provided with a coating crimping portion 11, a core wire crimping portion 12 and a terminal connecting portion 13. The coating crimping portion 11 is a part to be crimped to a coating in an end part of the wire 18. The core wire crimping portion 12 is a part to be crimped to a core wire exposed in the end part of the wire 18. The terminal connecting portion 13 is a part to be connected to a mating terminal and, for example, formed into a tubular shape. The coating crimping portion 11, the core wire crimping portion 12 and the terminal connecting portion 13 are linearly arranged in this order. The coating crimping portion 11 and the terminal connecting portion 13 are thicker than the core wire crimping portion 12. Thus, when the terminal 10 is observed from a lateral side, a recess 14 recessed in a part in an extension direction of the terminal 10 is formed between the coating crimping portion 11 and the terminal connecting portion 13 above the core wire crimping portion 12.

In this embodiment, the connector 20 holds a plurality of the terminals 10. More specifically, a plurality of (e.g. two) terminals 10 are held separately in each of a plurality of stages (e.g. two stages). In each stage, the plurality of terminals 10 are arranged in parallel in a row. Note that the plurality of terminals 10 may be terminals of the same size and same material or may be terminals of different sizes and different materials. Note that the number of the terminals 10 to be held by the connector 20 is arbitrary.

The connector 20 is provided with a housing 30 and the retainer 80. The plurality of terminals 10 at least in one stage are held not to come out from the housing 30 by the retainer 80. In this embodiment, the connector 20 is further provided with a cover 60. The cover 60 is attached to the housing 30 on a side opposite to the retainer 80. The plurality of terminals 10 in the other stage are held not to come out from the housing 30 by the cover 60.

In the following description, the side of the terminal connecting portion 13 and the side of the coating crimping portion 11 in the extension direction of the terminal 10 may be referred to as a front side and a rear side. Further, the side of the cover 60 and the side of the retainer 80 may be referred to as a lower side and an upper side. Further, a lateral direction may be referred to, assuming a state standing on the cover 60 and facing forward.

The housing 30 is made of resin or the like and provided with terminal accommodating portions 32, 42. In this embodiment, the housing 30 is provided with the terminal accommodating portion 32 on a lower side and the terminal accommodating portion 42 on an upper side. The lower terminal accommodating portion 32 includes cavities 34 for accommodating the terminals 10. In this embodiment, the lower terminal accommodating portion 32 includes a plurality of (here, two) cavities 34 arranged in parallel. The upper terminal accommodating portion 42 includes cavities 44 for accommodating the terminals 10. In this embodiment, the upper terminal accommodating portion 42 includes a plurality of (here, two) cavities 44 arranged in parallel.

The retainer 80 is united with the upper terminal accommodating portion 42 and holds the terminals 10 in the upper cavities 44. That is, the terminals 10 are inserted into the cavities 44 in a state before the retainer 80 is completely attached. With the terminals 10 inserted in the cavities 44, the retainer 80 is completely attached to the upper terminal accommodating portion 42. Then, the terminals 10 are prevented from coming out from the upper cavities 44. Note that a back side in an insertion direction of the terminal 10 into the cavity 44 is the front side, and an opposite side is the rear side.

The cover 60 is united with the lower terminal accommodating portion 32 and holds the terminals in the lower cavities 34. That is, the terminals 10 are set in the lower cavities 34 in a state before the cover 60 is attached to the lower terminal accommodating portion 32. In this state, the cover 60 is attached to the lower terminal accommodating portion 32. Then, the terminals 10 are prevented from coming out from the lower cavities 34.

It is not essential that this connector is provided with the cover 60 and the terminals 10 to be held by the cover 60.

A configuration for holding the terminals 10 by the retainer 80 is more specifically described.

### Holding Structure by Retainer

The retainer 80 is configured to be attachable to the housing 30 at a temporarily attached position and a completely attached position. Complete attachment is a state where the retainer 80 locks the terminals 10 to prevent the terminals 10 from coming out in a used state of the connector 20. With the retainer 80 attached to the housing 30 at the completely attached position, the terminals 10 are held in the cavities 44 without coming out from the housing 30 even if the connector 20 is carried or inserted into or withdrawn from a mating connector. Temporary attachment is a state where the retainer 80 is united with the housing 30 and can be integrally handled and the terminals 10 are insertable into the cavities 44 in a state before the completely attached state is reached. That is, in the temporarily attached state, the housing 30 and the retainer 80 can be stored, carried and provided to a worker who inserts the terminals 10 as one component.

More specifically, the housing 30 includes a partitioning plate portion 31 for partitioning the cavities 44 in the upper stage from below. In this embodiment, the partitioning plate portion 31 is located between the lower terminal accommodating portion and the lower terminal accommodating portion and partitions between the lower cavities 34 and the upper cavities 44. The partitioning plate portion 31 can be grasped as a bottom plate located on the bottoms of the cavities 44 in the upper stage. The housing 30 includes a pair of outer walls 43, 43 located on both sides of the housing 30. The pair of outer walls 43, 43 extend upward from both side parts of the partitioning plate portion 31. The pair of outer walls 43, 43 are plate-like parts orthogonal to the partitioning plate portion 31 and extending along an extension direction of the cavities 44. The pair of outer walls 43, 43 also extend along a projecting direction of locking wall portions 84 to be described later. The pair of outer walls 43, 43 are exposed on a left or right outer side of the housing 30.

Further, the housing 30 includes an intermediate wall 42M partitioning between the plurality of cavities 44 between the pair of outer walls 43, 43. That is, the pair of outer walls 43, 43 and the intermediate wall 42M are arranged in parallel at intervals in a width direction of the housing 30.

A front plate portion 31F extending in a direction orthogonal to a front-rear direction is provided on the front edge of the housing 30. The front plate portion 31F is located on the front ends of the cavities 44. The terminals 10 arranged in the cavities 44 are restricted from moving forward by contacting the front plate portion 31F. The front plate portion 31F is formed with connection holes 31Fa, through which mating terminals (e.g. male terminals including elongated plate portions or pin-shaped parts) are insertable. The mating terminal can be connected to the terminal 10 in the cavity 44 through this connection hole 31Fa.

Openings defined by the pair of outer walls 43 and the intermediate wall 42M on a side opposite to the partitioning plate portion 31 are at least partially closed by a ceiling plate portion 43c. The upper terminal accommodating portion 42 is configured to include an upper part of the partitioning plate portion 31, the pair of outer walls 43, the intermediate wall 42M, the ceiling plate portion 43c and the front plate portion 31F, and the plurality of cavities 44 are formed in gaps between the pair of outer walls 43 and the intermediate wall 42M. The cavities 44 include rear openings, and the terminals 10 are inserted into the cavities through the rear openings.

The housing 30 includes attachment openings 45, into which the retainer 80 is attached.

In this embodiment, the partially open attachment openings 45 are formed in an intermediate part in the extension direction of the cavities 44, out of the ceiling plate-like portion 43c of the housing 30. With the front end of the terminal 10 arranged in the cavity 44 held in contact with the front plate portion 31F, at least a part of the recess 14 of the terminal 10 can be exposed to the outside of the housing 30 through the attachment openings 45. By fitting the retainer 80 into the attachment openings 45, the retainer 80 closes the attachment openings 45 while being positioned in the front-rear direction.

The housing 30 includes a pair of temporary locking protrusions 46 and a pair of complete locking protrusions 48 projecting from the both outer side surfaces thereof. The pair of temporary locking protrusions 46 are located closer to the attachment openings 45 than the pair of complete locking protrusions 48. Thus, the retainer 80 attached to the housing 30 from the side of the attachment openings 45 is completely locked by the pair of complete locking protrusions 48 after being temporarily locked by the pair of temporary locking protrusions 46.

More specifically, parts of the pair of outer walls 43, 43 corresponding to the attachment openings 45 are recessed from other parts. The bottom surfaces of the recessed parts of the outer walls 43, 43 are parts of the outer surfaces of the outer walls 43 and the temporary locking protrusions 46 and the complete locking protrusions 48 are formed on these bottom surfaces.

The complete locking protrusion 48 is formed into a projection shape long along the front-rear direction. A length of the complete locking protrusion 48 is preferably maximally large in the recessed part of the outer wall 43 and, for example, more than half the front-rear length of the attachment opening 45.

The temporary locking protrusion 46 is located while being separated upward from the complete locking protrusion 48, and formed into a projection shape. A front-rear length of the temporary locking protrusion 46 may be smaller than that of the complete locking protrusion 48. In this embodiment, the temporary locking protrusion 46 is located above the front end of the complete locking protrusion 48. Further, the front-rear length of the temporary locking protrusion 46 is equal to or less than half that of the complete locking protrusion 48.

The retainer 80 is attachable to the housing 30 at the temporarily attached position and the completely attached position. The retainer 80 includes locking protrusions 83 lockable to the terminals 10 accommodated in the cavities 44.

With the retainer 80 attached at the temporarily attached position, the locking protrusions 83 are retracted from the cavities 34. Here, that the locking protrusion 83 is retracted from the cavity 44 means that the position of the locking protrusion 83 in the temporarily attached state is more separated from a center of the cavity 44 than the position of the locking protrusion 83 in the completely attached state. Thus, with the retainer 80 attached at the temporarily attached position, a part of the locking protrusion 83 may enter the cavity 44. That is, the locking protrusion 83 in the temporarily attached state may be less likely to hinder the insertion of the terminal 10 into the cavity 44 than the locking protrusion 83 in the completely attached state.

The retainer 80 can rotate from the temporarily attached position to the completely attached position. The retainer 80 is rotated in a predetermined range around an axis (here, an axis in a lateral direction) orthogonal to the extension direction of the cavities 44. By rotating the retainer 80 and locating the retainer 80 at the completely attached position, the locking protrusions 83 can project into the cavities 44 through the attachment openings 45 and lock the terminals 10 in the cavities 44.

More specifically, the retainer 80 includes a retainer body 82, a pair of the locking wall portions 84 and a pair of retaining protrusions 85.

The retainer body 82 is in the form of a plate, here a rectangular plate, spreading to be able to collectively close the attachment openings 45 corresponding to the plurality of cavities 44. The retainer body 82 is attached into the attachment openings 45 to close upper openings of the plurality of cavities 44.

The retainer body 82 is formed with the locking protrusions 83. Here, the plurality of locking protrusions 83 are formed in parallel to correspond to the plurality of cavities 44. The locking protrusion 83 is formed in an intermediate part in the extension direction of the cavities 44, more specifically a region where the core wire crimping portion 12 is to be located in the extension direction of the cavities 44. With the retainer body 82 attached in the attachment openings 45, the locking protrusions 83 can project into the cavities 44. In this state, the locking protrusion 83 can be fit into the recess 14 between the coating crimping portion 11 and the terminal connecting portion 13 of the terminal 10 in the cavity 44. In this way, the terminal 10 is positioned in the extension direction thereof and suppressed from coming out rearward.

The pair of locking wall portions 84 extend from both sides of the retainer body 82 along both sides of the housing 30, here the outer surfaces of the pair of outer walls 43, 43. The pair of retaining protrusions 85 are formed at positions near the tips of the inner surfaces of the pair of locking wall portions 84. The retaining protrusion 85 is an elongated protrusion projecting from the inner surface of the locking wall portion 84. In the temporarily attached state, the retaining protrusion 85 is along the extension direction of the cavities 44. In this embodiment, the tip edge of the locking wall portion 84 is along the extension direction of the cavities 44 in the completely attached state, and the retaining protrusion 85 is along the tip edge of the locking wall portion 84. The retaining protrusion 85 is shaped to have a guide surface 85f having a projecting dimension gradually reduced toward a tip side of the locking wall portion 84 (see FIGS. 3 and 8). The pair of locking wall portions 84 can be locked to the pair of temporary locking protrusions 46 or the pair of complete locking protrusions 48.

Further, the retainer 80 is supported movably along an inclination direction inclined to the extension direction of the cavities 44 at the temporarily attached position. The inclination direction is a direction away from the cavities 44 toward the rear side along the extension direction of the cavities 44. Since the retainer 80 is supported movably along the inclination direction, if the terminal 10 interferes with the locking protrusion 83 when being inserted into the cavity 44, the interference of the terminal 10 and the locking protrusion 83 can be eliminated by moving the retainer 80 rearward.

More specifically, an inclined temporary support groove 90 extending along the inclination direction is formed between the temporary locking protrusion 46 and the complete locking protrusion 48. A width of the inclined temporary support groove 90 is nearly equal to or larger than that of the retaining protrusion 85 within a range that the retaining protrusion 85 can be supported along the inclination direction. By arranging the retaining protrusion 85 in the inclined temporary support groove 90, the retaining protrusion 85 is supported in a posture along the inclination direction. The retaining protrusion 85 may be movable in the inclination direction in the inclined temporary support groove 90.

One groove side surface of the inclined temporary support groove 90 is a front-side groove forming surface 46f1, and the other groove side surface is a back-side groove forming surface 48f1. The front-side groove forming surface 46f1 is a lower side surface of the temporary locking protrusion 46 distant from the attachment opening 45. The back-side groove forming surface 48f1 is an upper side surface of the complete locking protrusion 48 near the attachment opening 45.

The back-side groove forming surface 48f1 is located near the front of the complete locking protrusion 48. For example, the back-side groove forming surface 48f1 is formed to spread rearward in a ½ to ¾ region from the front edge of the complete locking protrusion 48. The back-side groove forming surface 48f1 gradually obliquely extends downward toward the front with respect to a part of the complete locking protrusion 48 connected behind the back-side groove forming surface 48f1.

A part behind the back-side groove forming surface 48f1, out of the complete locking protrusion 48, is formed into a retainer spreading surface 48f2. The retainer spreading surface 48f2 is formed into a slope having a projecting length from the outer side surface of the housing 30 increasing with distance from the attachment opening 45 (see FIG. 8). A downward facing surface of the complete locking protrusion 48 on a side opposite to the attachment opening 45 is formed into a complete locking surface 48f3 for holding the retainer 80 at the completely attached position by being locked to the retaining protrusion 85 (see FIGS. 7 and 8).

In this embodiment, the retainer spreading surface 48f2 and the complete locking surface 48f3 are shaped to extend along the extension direction of the cavities 44 in a side view. Thus, in a side view of the complete locking protrusion 48, a part formed with the retainer spreading surface 48f2 is a continuous part having a constant width, and an upper part of a front part formed with the back-side groove forming surface 48f1 is shaped to obliquely descend toward the front.

If the retainer 80 is pushed with the retaining protrusions 85 arranged on the back-side groove forming surfaces 48f1, the retaining protrusions 85 contact the retainer spreading surfaces 48f2. Then, by pushing the retainer 80, the retaining protrusions 85 ride on the retainer spreading surfaces 48f2 and the locking wall portions 84 are resiliently deformed and expanded outward. If the retaining protrusions 85 ride downward over the complete locking protrusions 48, the locking wall portions 84 resiliently return to an original shape and the retaining protrusions 85 can be completely locked to the complete locking surfaces 48f3 of the complete locking protrusions 48 from below.

The temporary locking protrusion 46 is located forward of the rear edge of the back-side groove forming surface 48f1 in the extension direction of the cavities 44. That is, in a side view of the complete locking protrusion 48, the temporary locking protrusion 46 is located above a part extending obliquely downward toward the front side. That is, an arrangement space for the retaining protrusion 85 for temporary locking can be provided, effectively utilizing an obliquely descending space below the complete locking protrusion 48.

The front edge of the temporary locking protrusion 46 may be located rearward or forward of the front edge of the complete locking protrusion 48. In this embodiment, the front edge of the temporary locking protrusion 46 is located forward of the front edge of the complete locking protrusion 48.

The temporary locking protrusion 46 may extend further rearward than the rear edge of the back-side groove forming surface 48f1 in the extension direction of the cavities 44. In this case, the temporary locking protrusion 46 preferably extends rearward while increasing a vertical dimension thereof in terms of strength. In terms of further size reduction, the temporary locking protrusion 46 is preferably located forward of the rear edge of the back-side groove forming surface 48f1.

The back-side groove forming surface 48f1 and the front-side groove forming surface 46f1 are preferably in a posture more perpendicular to the outer surface of the outer wall 43, which is the side surface of the housing 30, than the retainer spreading surface 48f2. The back-side groove forming surface 48f1 and the front-side groove forming surface 46f1 are perpendicular to the outer surface of the outer wall 43 (see FIG. 7) in this embodiment, but may be inclined to this outer surface.

If the back-side groove forming surface 48f1 and the front-side groove forming surface 46f1 are in the posture nearly perpendicular to the outer surface of the outer wall 43, the retaining protrusion 85 is easily maintained in a state supported along the inclined temporary support groove 90.

Further, if the rear end of the retainer 80 is pushed, parts near the rear ends of the retaining protrusions 85 can easily ride over the retainer spreading surfaces 48f2 and the retainer 80 is easily rotated around the front ends of the retaining protrusions 85 with the front ends of the retaining protrusions 85 retained by the front-side groove forming surfaces 46f1.

Further, since the front end of the complete locking protrusion 48 needs not be formed into an inclined shape for expanding the retainer 80, it can be suppressed that the front end of the complete locking protrusion 48 becomes too thin.

With the retainer 80 temporarily attached, the locking wall portions 84 of the retainer 80 contact the front walls of recesses formed in the outer walls 43 and restrict a forward movement of the retainer 80. In this state, a part of the locking protrusion 83 may project into the cavity 44 through the attachment opening 45 (see FIG. 6). In this case, the inserted terminal 10 may contact the locking protrusion 83 and move the retainer 80 rearward.

A part configured to enter the cavity 44 with the retainer 80 located at the temporarily attached position, out of the locking protrusion 83, may have a retracted guiding surface 83f1 extending away from the cavity 44 toward the rear side. In this embodiment, a part near the front of the tip surface of the locking protrusion 83 is the retracted guiding surface 83f1. The retracted guiding surface 83f1 is a surface facing the terminal 10 from a push-in direction of the terminal 10 into the cavity 44 (from above) with the retainer 80 located at the completely attached position. The retracted guiding surface 83f1 is formed into a surface along an extension direction of the retaining protrusion 85. In the completely attached state, the retracted guiding surface 83f1 is along the extension direction of the cavities 44. In the temporarily attached state, a tip part of the retracted guiding surface 83f1 enters the cavity 44 while facing rearward with the retracted guiding surface 83f1 extending along the inclination direction, which is the extension direction of the retaining protrusion 85.

If the terminal 10 is inserted into the cavity 44, a tip part of the terminal 10 contacts the retracted guiding surface 83f1. Then, the tip part of the terminal 10 pushes the retracted guiding surface 83f1 outward of the cavity 44. In this way, the retainer 80 moves obliquely rearward and the locking protrusions 83 are retracted from the cavities 44. In this way, the terminal 10 can be inserted to the back of the cavity 44 without interfering with the locking protrusion 83.

The locking protrusion 83 has a retaining surface 83f2 continuous with the retracted guiding surface 83f1. The retaining surface 83f2 is a surface connected in front of the retracted guiding surface 83f1 and configured to retain the terminal 10 with the retainer 80 located at the completely attached position. The retaining surface 83f2 is preferably a surface orthogonal to the extension direction of the cavities 44, but this is not essential.

As described above, since the retainer 80 is configured to rotate around a front end part, the retaining surfaces 83f2 are easily positioned to enter the cavities 44 in the temporarily attached state. In such a case, the retracted guiding surface 83f1 facing the retaining surface 83f2 can smoothly guide the locking protrusion 83 in a direction retracting from the cavity 44 by the insertion of the terminal 10.

The housing 30 has retainer retention receiving surfaces 43f located behind the retainer 80 located at the temporarily attached position and capable of contacting the retainer 80 from behind. In this embodiment, the retainer retention receiving surface 43f is a surface on a rear side of the recess of the outer wall 43 and facing forward. The retainer retention receiving surface 43f is a surface orthogonal to the extension direction of the cavities 44. The retainer retention receiving surfaces 43f can contact rear parts of the locking wall portions 84 of the retainer 80 and restrict rearward detachment of the retainer 80.

The retainer 80 has inclined retaining surfaces 84f inclined with respect to the extension direction of the cavities 44 while being located at the temporarily attached position and facing the retainer retention receiving surfaces 43f while being located at the temporarily attached position. In this embodiment, the inclined retaining surface 84f is formed into an inclined surface facing forward toward a lower side in the completely attached state. The inclined retaining surface 84f is preferably parallel to the retainer retention receiving surface 43f in the temporarily attached state, but this is not essential.

If the retainer 80 is lowered toward the rear side, the inclined retaining surfaces 84f contact the retainer retention receiving surfaces 43f to restrict a rearward movement. At this time, the inclined retaining surfaces 84f can come into surface contact with the retainer retention receiving surfaces 43f in an allowed inclined posture of the retainer 80 being guided by the inclined temporary support grooves 90. In this way, even in a state where the retainer 80 is moved rearward, the retainer 80 can be stably in the inclined posture. Thus, after the insertion of the terminals 10, the retainer 80 can stably move forward to return.

### Terminal Holding Operation

A holding operation example of the terminals 10 is described.

An assembly in which the retainer 80 is temporarily attached to the housing 30 is prepared (see FIGS. 5 to 8). In this state, the retaining protrusions 85 of the retainer 80 are fit in the inclined temporary support grooves 90 and the retainer 80 is supported in a posture inclined with respect to the housing 30. The retaining protrusions 85 are in front of and beyond the complete locking protrusions 48. The retaining protrusions 85 are movable along an inclination direction of the inclined temporary support grooves 90 in the inclined temporary support grooves 90. Thus, the retainer 80 can move rearward in the inclined posture until the inclined retaining surfaces 84f contact the retainer retention receiving surfaces 43f. Further, front tip parts of the locking protrusions 83 project into the cavities 44 (see FIG. 6), and front end parts of the retracted guiding surfaces 83f1 are facing obliquely rearward in the cavities 44.

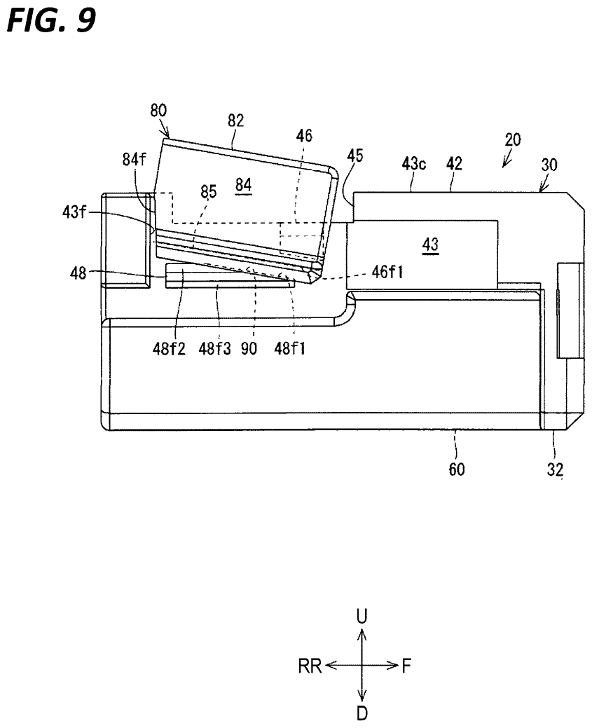

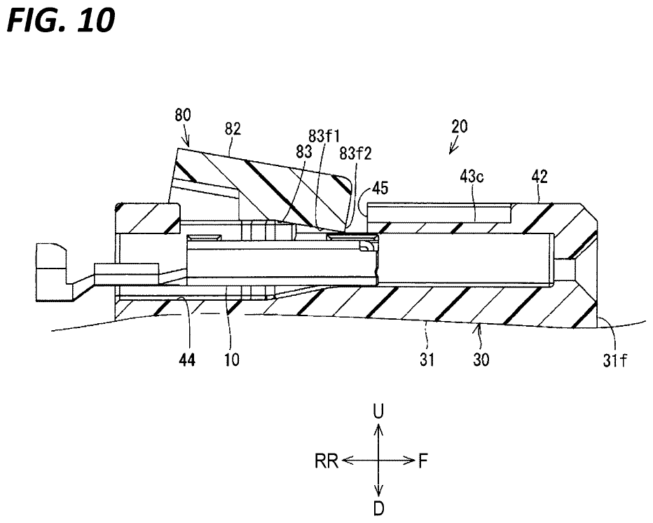

The terminal 10 is inserted into the cavity 44 through the rear opening of the cavity 44. Then, the tip of the terminal 10 contacts the retracted guiding surface 83f1 of the locking protrusion 83. If the terminal 10 is moved further backward, the tip of the terminal 10 pushes the retracted guiding surface 83f1 outwardly and rearwardly of the cavity 44 (see FIGS. 9 and 10). In this way, the retainer 80 moves in a direction separating from the cavities 44 along the inclination direction of the inclined temporary support grooves 90. Then, the terminal 10 can move further backward in the cavity 44. If the terminal 10 is inserted into the cavity 44 until contacting the inner surface of the front plate portion 31F, the recess 14 of the terminal 10 is arranged inside the attachment opening 45. In this way, the retainer 80 can return to an original position. The retainer 80 may return to the original position by its own weight or may be returned to the original position by a manual operation of a worker. If the retainer 80 returns to the original position, the front end parts of the locking protrusions 83 enter the cavities 44. Thus, the retaining surface 83f2 of the locking protrusion 83 can be hooked to the rear end of the terminal connecting portion 13 and the terminal 10 can be prevented from coming out when the retainer 80 is rotated to the completely attached position.

Subsequently, the retainer 80 is pushed toward the attachment openings 45. Note that a rear end part of the retainer 80 is preferably pushed into the attachment openings 45. If the retainer 80 is pushed, the guide surfaces 85f of the retaining protrusions 85 are pressed against the retainer spreading surfaces 48f2 of the complete locking protrusions 48, wherefore the locking wall portions 84 are expanded outward along the inclination of the retainer spreading surfaces 48f2. The front end parts of the retaining protrusions 85 hardly move upward since being locked to the front-side groove forming surfaces 46f1. Thus, the retainer 80 can rotate around the front end parts of the retaining protrusions 85. Particularly, the front-side groove forming surface 46f1 is in the posture more perpendicular to the outer surface of the outer wall 43 than the retainer spreading surface 48f. Thus, the rear end part of the retaining protrusion 85 can contact the retainer spreading surface 48f2 and easily ride over the complete locking protrusion 48, whereas the rear end part of the retaining protrusion 85 hardly rides over the front-side groove forming surface 46f1. Therefore, the retainer 80 can more reliably rotate around the front end parts of the retaining protrusions 85.

When riding over the complete locking protrusions 48, the retaining protrusions 85 are locked to the complete locking surfaces 48f3 of the complete locking protrusions 48. In this way, the retainer 80 is completely attached to the housing 30 while being located at the completely attached position.

In this state, the tip parts of the locking protrusions 83 of the retainer 80 enter the cavities 44 and are locked to the recesses 14 of the terminals 10. Thus, the terminals 10 are held not to come out rearward from the cavities 44.

### Effects, Etc.

According to the connector 20 configured as described above, the locking protrusions 83 are locked to the terminals 10 in the cavities 44 to hold the terminals 10 by rotating the retainer 80 from the temporarily attached position to the completely attached position. Thus, a configuration for movably supporting the retainer 80 can be reduced in size as compared to a configuration for moving the retainer in a direction orthogonal to the longitudinal direction of the terminals to position the terminals. For example, in a configuration for moving a retainer in a direction orthogonal to a longitudinal direction of terminals to position the terminals, spaces in which retaining protrusions are movable in parallel can be ensured in the side surfaces of a housing. In this embodiment, spaces enabling the retaining protrusions 85 to rotate may be provided in the side surfaces of the housing 30. Thus, the housing 30 can be reduced in size and the entire connector 20 can be reduced in size.

Further, the retainer 80 is supported movably along the inclination direction at the temporarily attached position. Thus, if the terminal 10 contacts the locking protrusion 83 during the insertion of the terminal 10, the locking protrusion 83 can move in a direction separating from the cavity 44 and the terminal 10 can be smoothly inserted.

Further, the retainer 80 is held at the temporarily attached position by arranging the pair of retaining protrusions 85 in the inclined temporary support grooves 90. In this state, the terminals 10 can be easily inserted into the cavities 44. If the retainer 80 is then pushed and rotated, the pair of retaining protrusions 85 are locked to the complete locking surfaces 48f3 beyond the pair of complete locking protrusions 48. In this way, the retainer 80 is held at the completely attached position and a configuration for retaining the terminals 10 is easily realized.

Further, the back-side groove forming surface 48f1 is located near the front of the complete locking protrusion 48, and the temporary locking protrusion 46 is located forward of the rear edge of the back-side groove forming surface 48f1. Thus, arrangement spaces for the temporary locking protrusions 46 and the complete locking protrusions 48 can be reduced in the vertical direction, which contributes to the size reduction of the connector 20.

Further, with the retainer 80 located at the temporarily attached position, the retaining protrusions 85 are fit between the nearly perpendicular back-side groove forming surfaces 48f1 and the front-side groove forming surfaces 46f1. Thus, the retainer 80 is more reliably easily held in the inclined posture. If the retainer 80 rotates, the retaining protrusions 85 contact the retainer spreading surfaces 48f2 and the pair of locking wall portions 84 are pushed apart from each other. In this way, the retaining protrusions 85 can ride over the complete locking protrusions 48 and be easily retained and locked to the complete locking protrusions 48.

Further, the locking protrusion 83 is formed with the retracted guiding surface 83f1. Thus, if the terminal 10 contacts the retracted guiding surface 83f1 of the locking protrusion 83 when the terminal 10 is inserted into the cavity 44, the locking protrusion 83 is guided in a direction retracting from the inside of the cavity 44. In this way, the terminal 10 is smoothly inserted into the cavity 44.

Further, the retaining surface 83f2 is connected in front of the retracted guiding surface 83f1. Since the retainer 80 is configured to rotate, the retaining surfaces 83f2 are easily positioned to enter the cavities 44 with the retainer 80 located at the temporarily attached position. In such a case, if the terminal 10 contacts the retracted guiding surface 83f1 of the locking protrusion 83 when the terminal 10 is inserted into the cavity 44, the locking protrusion 83 is guided in the direction retracting from the inside of the cavity 44 and the retaining surface 83f2 is also easily guided in the direction retracting from the inside of the cavity 44. In this way, the terminal 10 is smoothly inserted into the cavity 44.

Further, the retaining surfaces 83f2 also help to suppress rearward detachment of the terminals 10 during the rotation of the retainer 80.

Further, since the housing 30 has the inclined retaining surfaces 84f, the retainer 80 is suppressed from coming out rearward from a state located at the temporarily attached position.

Further, the retainer 80 has the inclined retaining surfaces 84f. Since the inclined retaining surfaces 84f are in contact with the retainer retention receiving surfaces 43f with the retainer 80 moved in a coming-out direction, the retainer 80 in a retained state is stably kept in the inclined posture. Thus, a state where the retaining protrusions 85 extend along the inclined temporary support grooves 90 is easily maintained. In this way, a return movement of the retainer 80 is smoothly made later.

### Modification

Note that the configuration for rotatably supporting the retainer 80 is not limited to the above example. For example, a retainer may be configured to rotate with respect to a housing by a configuration in which protrusions are formed on either a pair of locking wall portions of the retainer or a pair of outer surfaces of the housing and recesses, into which the protrusions are fit, are formed in the others.

Note that the respective configurations described in the above embodiment and each modification can be appropriately combined without contradicting each other.

### LIST OF REFERENCE NUMERALS

10 terminal
11 coating crimping portion
12 core wire crimping portion
13 terminal connecting portion
14 recess
18 wire
20 connector
30 housing
31 partitioning plate portion
31F front plate portion
31Fa connection hole
32, 42 terminal accommodating portion
34, 44 cavity
42M intermediate wall
43 outer wall
43c ceiling plate portion
43f retainer retention receiving surface
45 attachment opening
46 temporary locking protrusion
46f1 front-side groove forming surface
48 complete locking protrusion
48f1 back-side groove forming surface
48f2 retainer spreading surface
48f3 complete locking surface
60 cover
80 retainer
82 retainer body
83 locking protrusion
83f1 retracted guiding surface
83f2 retaining surface
84 locking wall portion
84f inclined retaining surface
85 retaining protrusion
85f guide surface
90 inclined temporary support groove

1. A connector for holding a terminal, comprising:
a housing formed with a cavity capable of accommodating the terminal; and
a retainer attachable to the housing at a temporarily attached position and a completely attached position,
the retainer including a locking protrusion lockable to the terminal accommodated in the cavity, and
the locking protrusion being retracted from the cavity with the retainer located at the temporarily attached position, the locking protrusion projecting into the cavity and locking the terminal in the cavity by rotating the retainer from the temporarily attached position to the completely attached position.

2. The connector of claim 1, wherein:
with a back side in an insertion direction of the terminal into the cavity set as a front side and an opposite side set as a rear side,
the retainer is supported movably along an inclination direction away from the cavity toward the rear side along an extension direction of the cavity at the temporarily attached position.

3. The connector of claim 1, wherein:
with a back side in an insertion direction of the terminal into the cavity set as a front side and an opposite side set as a rear side,
the housing includes an attachment opening, the retainer being attached into the attachment opening,
the retainer includes a retainer body to be attached into the attachment opening, a pair of locking wall portions extending from both sides of the retainer body along both sides of the housing and a pair of retaining protrusions projecting from inner surfaces of the pair of locking wall portions,
the housing includes a pair of temporary locking protrusions and a pair of complete locking protrusions projecting from outer surfaces on the both sides of the housing, the pair of temporary locking protrusions being located closer to the attachment opening than the pair of complete locking protrusions,
an inclined temporary support groove extending in an inclination direction away from the cavity toward the rear side along an extension direction of the cavity and supporting the retaining protrusion in a posture along the inclination direction is formed between the temporary locking protrusion and the complete locking protrusion, and
a surface of the complete locking protrusion on a side opposite to the attachment opening is a complete locking surface for keeping the retainer at the completely attached position by being locked to the retaining protrusion.

4. The connector of claim 3, wherein:
a back-side groove forming surface forming one groove side surface of the inclined temporary support groove, out of the complete locking protrusion, is located near front of the complete locking protrusion, and
the temporary locking protrusion is located forward of a rear edge of the back-side groove forming surface in the extension direction of the cavity.

5. The connector of claim 4, wherein:
a part rearward of the back-side groove forming surface, out of the complete locking protrusion, is formed into a retainer spreading surface having a projecting length from an outer side surface of the housing increasing with distance from the attachment opening, and
the back-side groove forming surface and a front-side groove forming surface forming the other groove side surface of the inclined temporary support groove, out of the temporary locking protrusion, are in a posture more perpendicular to the side surface of the housing than the retainer spreading surface.

6. The connector of claim 2, wherein a part configured to enter the cavity with the retainer located at the temporarily attached position, out of the locking protrusion, is formed into a retracted guiding surface extending away from the cavity toward the rear side.

7. The connector of claim 6, wherein:
the retracted guiding surface is a surface facing the terminal from a direction to push the terminal into the cavity with the retainer located at the completely attached position, and
a retaining surface for retaining the terminal with the retainer located at the completely attached position is connected in front of the retracted guiding surface.

8. The connector of claim 2, wherein the housing has a retainer retention receiving surface located behind the retainer located at the temporarily attached position to contact the retainer from behind.

9. The connector of claim 8, wherein:
the retainer has an inclined retaining surface inclined with respect to the extension direction of the cavity in a state located at the completely attached position and facing rearward to face the retainer retention receiving surface in a state located at the temporarily attached position, and
the inclined retaining surface contacts the retainer retention receiving surface to retain the retainer.
